(19) United States
(12) Patent Application Publication
(10) Pub. No.: US 2023/0184874 A1
(43) Pub. Date: Jun. 15, 2023

(54) Sympathetic Personal Locator Beacon Relay System

(71) Applicant: Joseph Sojan Parampathu, Irvine, CA (US)

(72) Inventor: Joseph Sojan Parampathu, Irvine, CA (US)

(21) Appl. No.: 17/549,891

(22) Filed: Dec. 14, 2021

(51) Int. Cl. G01S 5/02; G08B 25/01

(52) U.S. Cl. CPC G01S 5/0231; G08B 25/016; G01S 5/0284; H04W 4/90

(57) ABSTRACT

A sympathetic emergency beacon system including a receiver for emergency beacon transmissions and a transmitter to relay transmissions. Personal Locator Beacons (PLBs), Emergency Position Indicating Radio Beacons (EPIRBs), and Emergency Locator Transmitters (ELTs) are used in emergency scenarios to provide location information regarding downed personnel, vessels, or aircraft. These signals notify search and rescue operations of the location of the distress signal. The sympathetic beacon system computes precise position information regarding the received signal and transmits this computed position information to search and rescue operators for more quickly locating the emergency situation. By automatically relaying the distress signal through a plurality of passive receivers, the present invention strengthens the reliability of emergency locating systems.

### TECHNICAL FIELD

The present invention relates generally to the field of emergency locator beacons, and more specifically, to systems to detect emergency locator beacon transmissions and decode transmissions to aid emergency responses.

### BACKGROUND

Vessels, aircraft, and personnel operating in remote locations often carry emergency locator transmitters in case of incapacitation or other need. Emergency Position Indicating Radio Beacon (EPIRBs) for vessels, personal locator beacons (PLBs), and emergency locator transmitters (ELTs) generally perform these functions. A worldwide system of receivers monitors the transmission of emergency distress signals on reserved frequencies to dispatch search and rescue or other emergency responses in these situations.

Prior art emergency beacon systems provide only a distinct, repeating noise on the reserved frequency, but do not provide precise position data. Newer systems integrated with registration lists allow for a decoding that can provide contact information for the beacon owner to emergency personnel. In both systems, the precise location of the actual distress signal may be unknown for a lengthy period of time, as dedicated rescue aircraft, vessels, and personnel must canvas the area searching for the distress signal.

In emergency response, even short delays can drastically reduce the likelihood of a positive outcome.

### SUMMARY

In a broad aspect, the present invention provides an emergency locator beacon system comprising: at least one individual emergency beacon device with the capability to transmit an emergency beacon, the emergency beacon device having a transceiver; a plurality of receivers or relay systems, each receiver or relay system configured to: transmit the emergency beacon system to other receivers with the effect of increasing the range of the overall locator beacon system over that of a single receiver and single transmitter; a means of calculating the distance and/or direction of the emergency beacon transmission, such as through comparisons of subsequent signals; a means of displaying and/or relaying the computed position of the transmitting emergency beacon to other actors such as search and rescue personnel; and the capability to alert an operator of the emergency beacon receiver that an emergency distress signal has been received.

In another broad aspect, the present invention provides an emergency locator beacon system comprising: at least one individual emergency beacon device with the capability to transmit an emergency beacon, the emergency beacon device having a transceiver with the capability to compute and transmit locational data such as positional GPS; a plurality of receivers or relay systems, each receiver or relay system configured to: transmit the emergency beacon system to other receivers with the effect of increasing the range of the overall locator beacon system over that of a single receiver and single transmitter; a means of decoding and relaying or separately calculating the distance and/or direction of the emergency beacon transmission, such as through comparisons of subsequent signals; a means of displaying and/or relaying the position of the transmitting emergency beacon to other actors such as search and rescue personnel; and the capability to alert an operator of the emergency beacon receiver that an emergency distress signal has been received and the location of the emergency transmission.

In another broad aspect, the present invention provides an emergency locator beacon system comprising: numerous emergency beacon transmitters and receivers providing decentralized information to all users of currently or recently transmitting emergency beacons, such as through open network access for all connected users, or through broadcasting through radio frequencies, including, in certain embodiments, interpolated position information for the transmitting emergency beacons.

In another broad aspect, the present invention provides an emergency locator beacon system comprising: emergency beacon transmitters, sympathetic transmitters and relays, and passive receivers, such as through a connected peer-to-peer network of transmitters and relays allowing any interested parties, such as those responsible for the operation of the emergency beacon transmitting unit, or other actors, to participate in joint emergency response or recovery efforts.

In another broad aspect, the present invention provides an emergency locator beacon system comprising: emergency beacon transmitters, sympathetic transmitters and relays, and passive receivers, such as through a connected peer-to-peer network of transmitters and relays allowing any interested parties, such as those responsible for the operation of the emergency beacon transmitting unit, or other actors, to participate in a marketplace of rescue and recovery operators conducting live-bidding on the emergency response or accident recovery efforts.

### BRIEF DESCRIPTION OF THE DRAWINGS

The invention will be better understood by way of the following detailed description of embodiments of the invention with reference to the appended drawings, in which:

FIG. 1 is a schematic diagram illustrating the emergency beacon locator relay system, according to an embodiment of the present invention;

FIG. 2 is a schematic flow diagram illustrating a method for decision-making processes by passive recipients of beacon transmissions, according to an embodiment of the present invention;

FIG. 3 is a schematic diagram illustrating a means for displaying computed and decoded emergency beacon locator relay system information for use by emergency operators, according to an embodiment of the present invention.

### DETAILED DESCRIPTION

The present invention relates to a sympathetic emergency beacon locator system in which receivers attuned to emergency distress signals relay these messages to increase the robustness of emergency response systems and to increase the chances of successful response or recovery efforts.

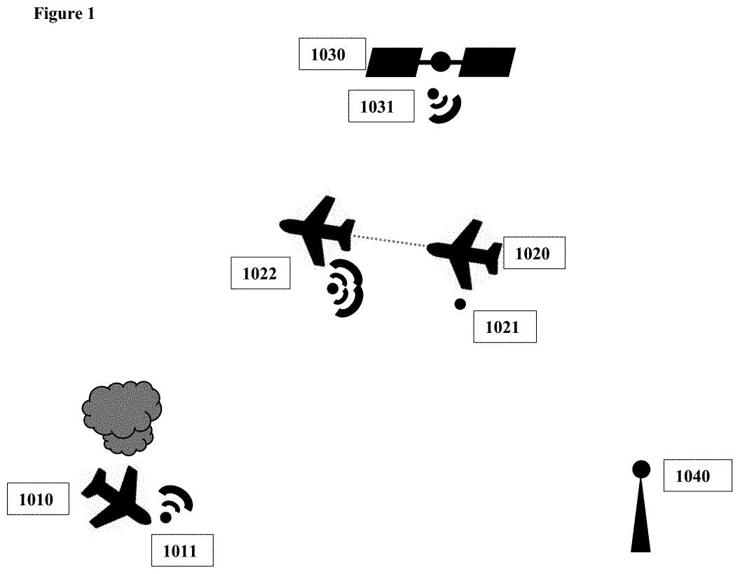

In accordance with a non-limiting example of implementation of an embodiment of the present invention, an emergency locator beacon sympathetic relay system is illustrated in FIG. 1. The system includes a plurality of an distress unit 1010 with an emergency locator beacon 1011, a passive carrier 1020 with an emergency locator receiver 1021 and emergency locator relay transmitters 1022, a satellite unit 1030 with an emergency locator receiver/transmitter 1031, and emergency locator decoder 1040. In the example illustrated in FIG. 1, the emergency locator beacon transmitter 1011 is within range of at least emergency locator receiver 1021. The passive carrier 1020 may include capabilities to calculate the location of distress unit 1010 such as through interpolation of passive carrier 1020's own relative position compared to distress unit 1010. The passive carrier 1020 transmits emergency information using emergency locator relay transmitter 1022 either to emergency locator decoder 1040 or to satellite unit emergency locator receiver/transmitter 1031 which subsequently relays the emergency information to emergency locator decoder 1040.

The distress unit 1010 transmits a distress signal through an emergency locator beacon 1011 when undergoing or experiencing certain conditions reflecting an emergency or distress condition. This distress signal may not include information beyond the existence of a distress situation, and in older models may not even include registration information to contact those responsible for the distress unit 1010 to pass detailed information to search and rescue operators.

Passive carrier 1020 may be conducting normal operations unrelated to the distress unit 1010 when passive carrier 1020's emergency locator receiver 1021 alerts to the emitted distress signal. Passive carrier 1020 may utilize relative position information, such as through calculations performed on the differences in signal distance from emergency locator beacon 1011 and emergency locator receiver 1021 at different positions. Passive carrier 1020 may use onboard computing to thus determine the position of distress unit 1010 and may use emergency locator relay transmitter 1022 to forward this interpolated position information to additional units of the emergency locator beacon sympathetic relay system.

Passive carrier 1020 may relay emergency information, including any additional computed information such as the interpolated position of distress unit 1010, to additional units of the emergency locator beacon sympathetic relay system by means of emergency locator relay transmitter 1022. In certain situations, it may be possible and beneficial for emergency information transmitted by emergency locator relay transmitter 1022 to be directly received by emergency locator decoder 1040 for decoding and notification of search and rescue operations. In other situations, due to the inability of emergency locator relay transmitter 1022 to be directly received by emergency locator decoder 1040 due to obstructions such as terrain and low altitude of passive carrier 1020, it may be beneficial for emergency information transmitted by emergency locator relay transmitter 1022 to be first received by satellite unit 1030 through emergency locator receiver/transmitter 1031, and then be relayed from emergency locator receiver/transmitter 1031 to emergency locator decoder 1040 for decoding and notification of search and rescue operations.

The emergency locator beacon sympathetic relay system as shown in FIG. 1 may include multiple intermediate relays by multiple passive carriers 1020 each utilizing their own emergency locator receivers 1021 and emergency locator relay transmitters 1022, relaying emergency information to emergency locator decoder 1040 either directly, or by way of satellite unit 1030. Emergency locator decoder 1040 may then decode the incoming messages and determine the appropriate information to pass to search and rescue operators for optimum recovery or response.

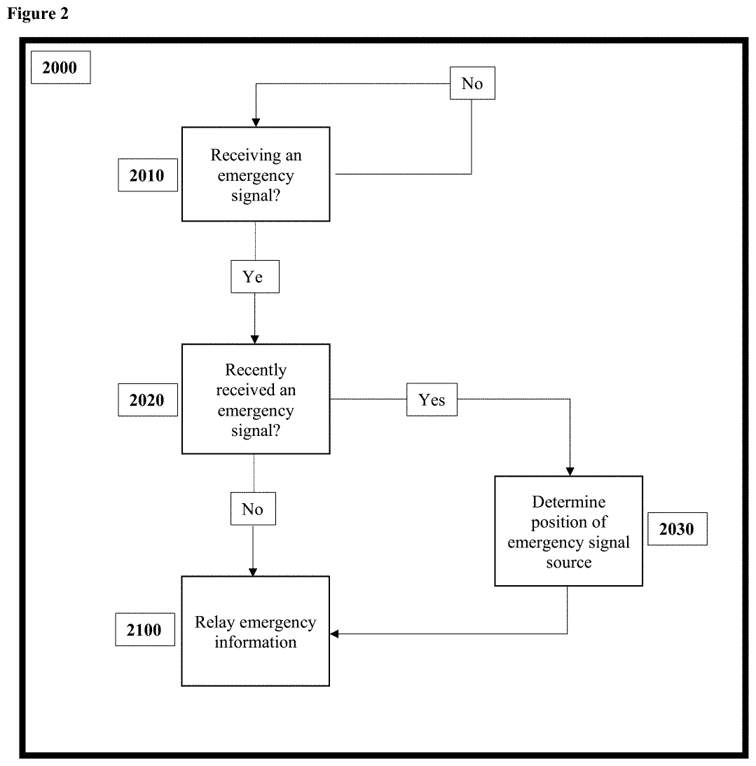

FIG. 2 illustrates a decision-making process 2000 followed by, with reference to FIG. 1, emergency locator receivers 1021 and emergency locator relay transmitters 1022 aboard one or more passive carriers 1020, in accordance with a non-limiting example of implementation of the present invention. The decision-making process 2000 begins with the passive emergency locator receivers 1021 which loops through receiver evaluation process 2010 until an emergency signal is received. If an emergency signal is received, the decision-making process 2000 and receiver evaluation process 2010 evaluates to “Yes”, decision-making process 2000 performs repeating signal evaluation 2020 which determines whether the signal has been received by the decision-making process 2000 previously, and if so, determines the position of the distress signal through position determination process 2030. If an emergency signal has not been recently received, the repeating signal evaluation 2020 evaluates to “No” and the relay emergency information process 2100 begins, relaying sympathetic emergency information which may be received by other passive carriers 1020, satellite units 1030, or emergency locator decoders 1040.

The decision-making process 2000, when implemented by various entities simultaneously receiving a repeating distress signal, has the effect of amplifying the range and salience of emergency information. This information, which in other contexts may be expected to be superfluous or unnecessary, in emergency situations such as search and rescue can be critical. The redundant possibility of several passive carriers 1020 providing continuously updated position information regarding the same distress unit 1010 allows personnel at emergency locator decoder 1040 site and subsequent personnel responsible for deployment of search and rescue operations the ability to sift through all information and use redundant transmissions as confirmation of actual distress situations. This raw information, redundant and salient, can be distilled for relay to search and rescue operators, with subsequent updates to account for any changes or to confirm that the emergency locator beacon sympathetic relay system continues to validate the prior position information and presence of distress unit 1010 transmitting an emergency signal.

In the event of accidental or erroneous transmission of emergency locator transmitters, decision-making process 2000, when implemented by various entities simultaneously receiving a repeating distress signal, has the effect of additionally providing to the emergency locator beacon sympathetic relay system information regarding the possibility that a distress unit 1010 has ceased transmission. In various circumstances, if a distress unit 1010 is believed to have terminated its distress situation, this may be due to an inadvertent transmission being discovered and remedied, the distress situation being successfully remedied, or the failure of the emergency locator beacon 1011 due to some other issue. In each of these issues, continuing to monitor for subsequent information, or the lack of further reported transmissions can provide helpful clues to emergency monitoring personnel operating at or in conjunction with emergency locator decoders 1040 sites. These personnel can use previously received transmissions through the emergency locator beacon sympathetic relay system, including those with position information derived and transmitted through decision-making process 2000, to determine the likelihood of an actual distress situation continuing to exist. Due to present constraints on emergency personnel and the prohibitive costs of deploying resources to all transmissions of emergency distress signals, distress signals are first confirmed to be actual distress conditions prior to deploying search and rescue operators. The present invention provides means to more quickly and precisely assess emergency beacon transmissions to determine whether search and rescue operations ought to commence, improving the likelihood for positive outcomes in actual distress situations.

Many additional and/or different tracking, alert, display, notification or other options are also possible and may be implemented by the decision-making process 2000 for improving the experience and information afforded to the users and operators.

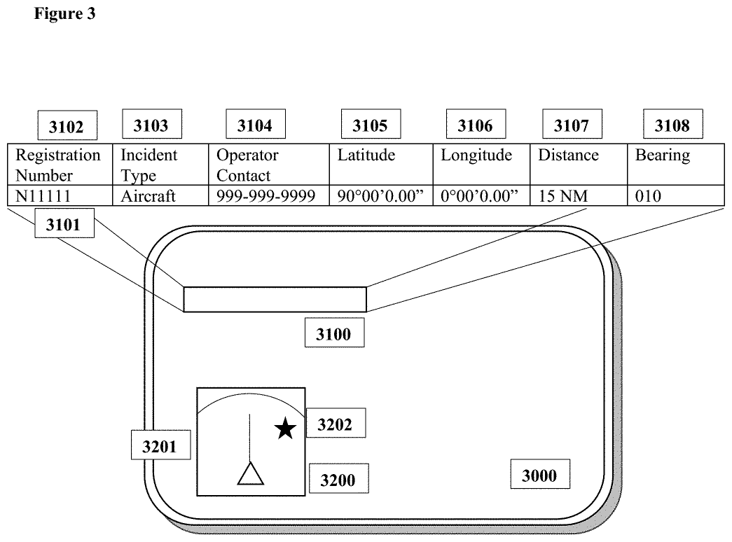

FIG. 3 illustrates a graphical display system 3000, according to an embodiment of the present invention, which may provide enhanced visual cues to aid responding personnel such as emergency personnel or search and rescue operators to more easily determine the relative position of the distress unit 1010 so as to more effectively respond to the distress situation. In accordance with a non-limiting example of implementation of the present invention, graphical display system 3000, may comprise: a text-based display 3100, and a graphical position display 3200. In one embodiment of the present invention, text-based display 3100 may display information table 3101, comprising: registration number 3102, incident type 3103, operator contact information 3104, distress unit latitude 3105, distress unit longitude 3106, relative distance 3107 between rescue operator and distress unit 1010, and relative bearing 3108 between rescue operator and distress unit 1010. In one embodiment of the present invention, graphical position display 3200 may display graphical representation of spatial position 3201 of the emergency operator and a graphical representation of relative position 3202 of distress unit 1010.

In the event of a distress unit 1010 transmitting a distress signal, emergency operators or other responding personnel equipped with graphical display system 3000 may more easily determine the relative position of the distress unit 1010 so as to more effectively respond to the distress situation. Responding personnel equipped with graphical display system 3000 may utilize information contained in text-based display 3100, populated with registration number 3102 and operator contact information 3104 from emergency beacon transmitter registration lists, incident type 3103, input by personnel at emergency locator decoder 1040 site, and distress unit latitude 3105, distress unit longitude 3106 calculated either by passive carriers 1020 implementing decision-making process 2000 and position determination process 2030, or by personnel at emergency locator decoder 1040 site. Emergency operators' position equipment, can be used to computer and display relative distance 3107 between rescue operator and distress unit 1010, and relative bearing 3108 between rescue operator and distress unit 1010, based on information the operator's position information and distress unit latitude 3105, distress unit longitude 3106. Registration number 3102 can provide useful information regarding the type of aircraft or vessel involved so as to determine the nature and scope of the distress situation, such as the number of personnel likely to be involved. Operator contact information 3104 can be used by emergency personnel to follow up with the operator on any questions that might aid recovery or response, as well as to provide information to any concerned parties, such as family members of passengers and crew.

Graphical display system 3000, may further be used by emergency operators to more easily determine the relative position of the distress unit 1010 and more effectively respond to the distress situation by use of graphical position display 3200 to maneuver emergency personnel and resources (such as rescue aircraft or vessels) towards distress unit 1010 using graphical representation of relative position 3202 and an understanding of graphical representation of spatial position 3201. The graphical position display 3200 can be used by emergency personnel as a navigation device providing simple symbolic representation of the path that will most directly lead to distress unit 1010. The present invention provides means to more quickly and precisely assess emergency beacon information to guide search and rescue operations, improving the likelihood for positive outcomes in actual distress situations.

### CONCLUSION, RAMIFICATIONS, AND SCOPE

Thus, the reader will see that the method and apparatus for the sympathetic emergency beacon locator system provides a more robust and immediate means of transmitting emergency distress signals over a network of receivers for emergency response and recovery operations.

While the above description contains many specifications, these should not be construed as limitations of the scope of the invention, but rather as an exemplification of a preferred embodiment of the invention. Many other variations and embodiments are possible. Accordingly, the scope of the invention should be determined not by the embodiment illustrated, but by the appended claims and their legal equivalents.

### STATEMENT OF NO NEW MATTER

This substitute specification contains no new matter.

What is claimed is:

1. An emergency locator beacon system comprising:
a. At least one emergency beacon system providing a distress signal;
b. A plurality of receivers for the distress signal with:
i. A computing device to calculate the distance between the distress signal and the receiver;
ii. A means of relaying the distance calculation via signal;
iii. A means of relaying a sympathetic distress signal;

2. An emergency locator beacon system as defined in claim 1, wherein said plurality of receivers comprises:
a. A means of combining the distance calculation and sympathetic distress signal as a combined complex transmission;
b. A means of decoding relayed transmissions;

3. An emergency locator beacon system as defined in claim 2, wherein:
a. Relayed transmissions can improve the locating of distress signals;
h. Position data information can improve accuracy and reliability of emergency information.

4. An emergency locator beacon system comprising:
a. At least one emergency beacon system providing a distress signal;
b. A plurality of receivers for the distress signal with:
i. A computing device to calculate the distance between the distress signal and the receiver;
ii. A means of relaying the distance calculation via signal;
iii. A means of relaying a sympathetic distress signal.

5. An emergency locator beacon system as defined in claim 4, further comprising:
a. A means for displaying the computed position of the distress signal;
b. A means to display historical position information computed and relayed through said emergency locator beacon system;
c. A means for users to access the displayed position information, wherein:
i. Users may infer the likelihood that an actual distress condition exists;
ii. Users may use historical position information to determine likelihood that a distress condition continues to exist;
iii. Users may use available information to make decisions regarding whether to deploy resources and what types of resources will be suited to provide assistance;
iv. Users may use historical position information to determine relative position and aid in navigation to the distress location.
